(19) United States
(12) Patent Application Publication
(10) Pub. No.: US 2008/0103865 A1
(43) Pub. Date: May 1, 2008

(54) Means and Method for Providing Real Time Services and Information

(76) Inventor: John Casson, Kingsbridge (GB)

Correspondence Address: DUNCAN G. BYERS PC, 355 CRAWFORD ST. SUITE 720, PORTSMOUTH, VA, 23510, US

(21) Appl. No.: 11/554,466

(22) Filed: Oct. 30, 2006

(51) Int. Cl. G06Q 10/00; G06F 17/00; G06F 17/30; G06Q 20/00; G06F 17/40

(52) U.S. Cl. 705/9; 705/1

(57) ABSTRACT

A system and method for real time services and information to clients. The system provides means for a consumer to enter into a service agreement with a service provider from any location in the world; the services can be requested at any time from any location, and have the service provider can provide immediate services and information based upon the consumer's request. Each service response is tailored to the particular needs of the customer and the customer's request. In one embodiment, an information system is provided that allows an individual or other entity to enter into a contractual relationship for services. In another embodiment, the contractual relationship is entered into by way of an interface with the service provider's location on the World Wide Web. In another embodiment, customers are provided with unique identification cards each with a unique card identification number.

### BACKGROUND OF THE INVENTION

This invention relates to means and methods for providing real time services and information to clients. More particularly, the present invention relates to providing means for a consumer to enter into a service agreement with a service provider from any location in the world. The present invention further provides means for a consumer to request services at any time from any location, and have the service provider provide immediate services and information based upon the consumer's request.

Maritime companies face many concerns, from the need for access to information on an as-needed r emergency basis. Such information may include port and weather information, local laws and guidelines for merchant vessels and crews, and the like. Such information is required on an emergency or immediate need basis, whether at sea or in port, and under all conditions and without regard to time or place. Security issues are foremost in the concerns of large and small companies, and must be attended to by all members of the industry from the corporate offices to the ships' captains, crews, port managers, dock workers, and those whose cargo and personnel are being moved across the navigable waters of the world.

In order to meet those concerns, many maritime companies turn to outside resources to meet growing security concerns. However, providing both long-term and immediate responses to maritime security needs can be problematic. Relationships have to be established with companies providing security services, and twenty-four hour a day access to services, such as the immediate deployment of security personnel, is critical. Once an emergency has occurred (security or otherwise), ships need immediate action to provide other responses, such as clearance for port calls to repair damage, provide medical care, or coordinate with national or local police forces to deal with issues such as piracy.

Complete maritime security services may include uniformed Security Officers for on board or in port security and immediate deployment of the same, International Ship and Port Facility (ISPS) and related Regulatory Compliance programs, training for Vessel or Facility Security Officers, ISPS audits, SSAS Monitoring, SSAS annexes and security consulting, as well as other services. Those other services may include regulatory compliance certification services, to include vessel and facility assessments, plans and training for crew and/or facility employees as well as ship or facility officer dedicated courses. A full service audit may also be provided for vessels and port facilities.

Providing such services requires contracts to be entered into between maritime interests and the companies that provide such services. The contracts are preferentially entered into prior to any services being ordered, but may also be entered into at the time that the services are requested.

Modern communications provide a framework within which such relationships and requests for services may be provided. Almost without exception, modern vessels (and port facilities) have access to the World Wide Web (the “Web”) through satellite or other communication means. Voice communications are also commonplace, allowing direct communication between a vessel or port and service providers throughout the world. There is a need, currently, to piggyback information and services via the existing communication means, as well as being adaptable to new technologies for information and data transfer as they become available.

What is needed, therefore, is a means to enter into service contracts with maritime concerns at a distance, and to positively identify such maritime concerns that have existing contracts with the service provider or immediately establish contracts with maritime concerns on an as-needed basis. In addition, there is a need to include the ability to provide information and services via current communication technologies.

### SUMMARY OF THE INVENTION

It is an object of the present invention to provide a means for providing a registration and order process for individuals and other entities to contract for services.

It is a further object of the present invention to provide a means for furnishing information and services.

It is a further object of the present invention to provide a means for furnishing information and services on an as-needed basis.

It is a further object of the present invention to provide a means for furnishing information and services via existing electronic communication systems.

It is a further object of the present invention to provide a means for furnishing information and services via data communications systems such as the World Wide Web.

In a first embodiment, and in accordance with the above and further objects of the present invention that will be obvious to one skilled in the art, an information system is provided that allows an individual or other entity to enter into a contractual relationship for services.

In another embodiment, the contractual relationship is entered into by way of an interface with the service provider's location on the World Wide Web.

In another embodiment, customers are provided with unique identification cards each with a unique card identification number.

In another embodiment, customers may access information and/or services via an interface with the service provider's location on the World Wide Web.

In another embodiment, customers may access information and services via voice communication systems.

In another embodiment, customers are provided with information and/or services in response to specific requests or inquiries by the customers.

In another embodiment, clients are provided with information and/or services in response to specific requests or inquiries by the clients wherein the interface between the client and service provider is via electronic communications.

In another embodiment, client registration is verified against a client database.

### BRIEF DESCRIPTION OF THE DRAWINGS

FIG. 1 is a flow chart setting forth the process by which a customer will register for services and order unique identification cards;

FIG. 2 is a flow chart setting forth the process by which a customer may register a unique identification card;

FIG. 3 is a flow chart setting forth the process by which unique identification cards are authenticated for dispatch to a customer;

FIG. 4 is a flow chart setting forth the process by which a registered card holder's request for services is processed;

FIG. 5 is a flow chart setting forth the process by which a request for services is assigned to personnel for resolution, namely “tasked out”, and tracked.

### DESCRIPTION OF A PREFERRED EMBODIMENT

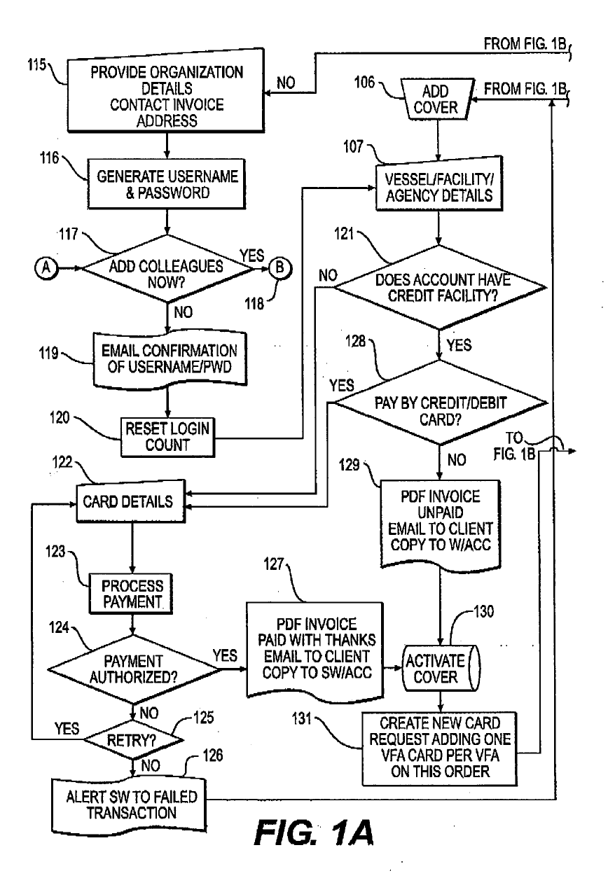

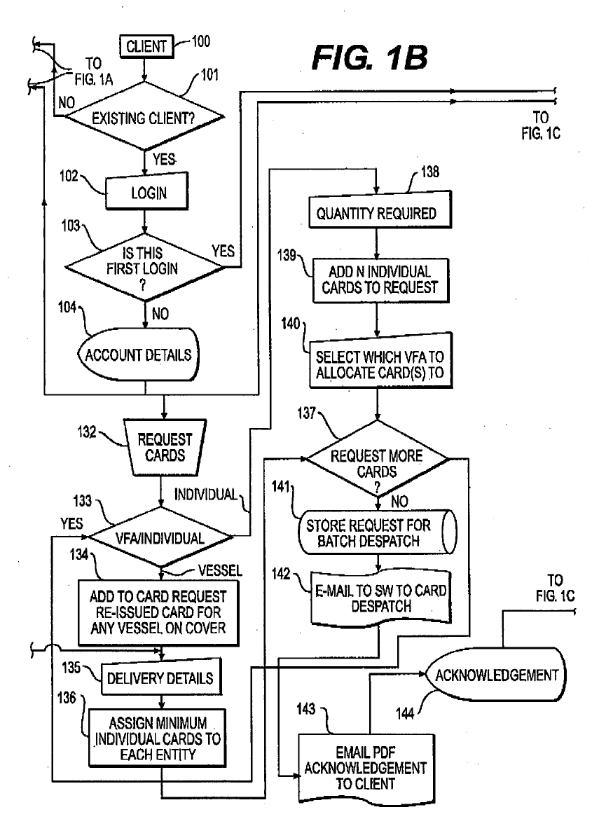

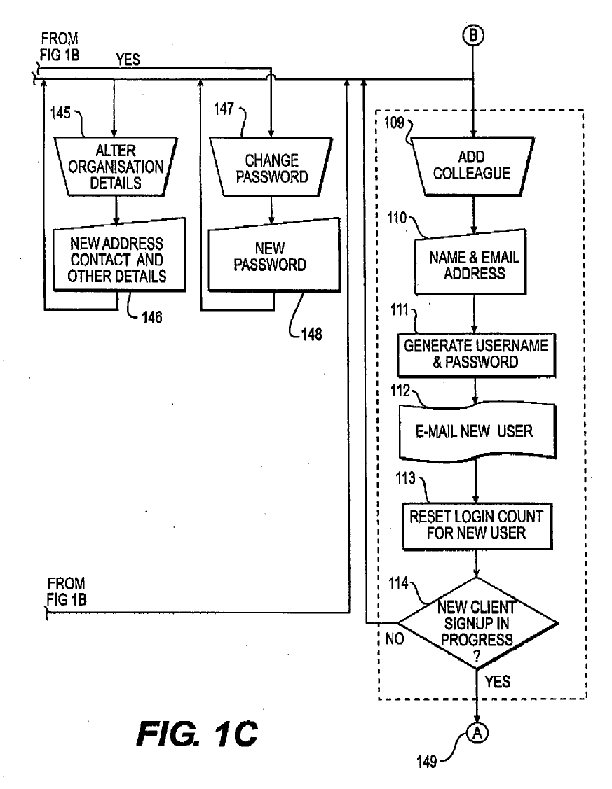

Referring to FIG. 1, a client 100 makes initial contact with the service provider through the service provider's website. The client 100 is identified 101 as either an existing client of the service provider or not an existing client of the service provider. If the client is an existing client of the service provider, the client 100 may login 102. Once the client has logged in 102 as an existing client, the system identifies 103 whether or not this is the first time that the client has logged in since becoming a client of the service provider. If the client is identified 103 as logging in for the first time, the client is prompted 147 to change its password. A new password is assigned 148, and the client is then directed to the account details stage 104. A client who is not identified 103 as loggin in for the first time is also directed to the client account details stage 104. The client account details stage 104 provides a screen which shows the following: 1) the client's current vessels, facilities and/or agencies covered under contract with the service provider, 2) the start and stop dates for coverage for each particular vessel, facility or agency; and 3) the account details, such as payment due dates and renewal dates for coverage. At that point, a client may choose to request 132 maritime assistance cards as described below, may add 109 a colleague as described below, may add 106 coverage for the requested services to the existing client account, or may alter 145 client/organization details. If the client chooses to add 106 coverage, information is gathered as described below for a new client, beginning with the identification 107 of vessel, facility, or agency details. If the client chooses to alter 145 organization details, the client is prompted 146 to enter the new address, contact, or other client details that may have changed from that originally provided to the service provider by the client.

If the client is not an existing client of the service provider, the client is prompted to provide 115 organization details, contact information, and invoicing address. A username and password are generated 116 for the client. At that point, the client chooses whether or not to add a colleague 117. Adding 109 a colleague may only be accomplished if the client is signed in to the original master account; colleagues of a client cannot add additional colleagues.

Colleagues may be selected to receive additional access cards based on the same master account; this is particularly useful, for example, where a single client operates multiple vessels and requires specific access cards uniquely identified for each individual vessel. If the client chooses to add a colleague, the client is redirected 118 to the sub-process by which a colleague is added 109. In that process, the name and email address for the colleague are provided by the client 110, and a unique username and password for the colleague are generated 111. The colleague, as a new user, is contacted 112 via email to confirm the information, and the login count for the new user is reset 113. It is determined 114 if the colleague was added during the new client signup process; if so, the client is redirected to choose whether or not to add an additional colleague 117. If the client chooses to add a colleague after the client has completed the new client order process, the client is redirected to either the alter organization details 145 path, the request cards 132 path, or the add cover 106 path. Alternatively, the client may also be redirected to login. It should also be noted that the option of adding a colleague 109 is provided as one of several options available after an existing client logs in 102 and is provided its account details 104.

When a client is prompted to add a colleague 117, if the client declines, the client is sent an email confirmation 119 of the username and password unique to that client. To differentiate the count of new clients versus existing clients, the login count is reset 120, and the client provides vessel/facility/agency details 107. It is determined if the client account has an established credit account or “credit facility” 121, and if so, the client is prompted to choose 128 if they would like to pay by credit or debit card. If not, the client is invoiced 129 via email with accounting copied, and coverage for the requested services on the client's account is activated 130. A client may not access credit facilities for services, however, unless and until payment is made or the service provider authorizes the client to receive services on credit with the service provider.

If the client's account does not have credit facility 121, credit/debit card details are obtained 122 for the client and the payment is processed 123. Similarly, if the client chooses 128 to pay by credit or debit card, credit/debit card details are obtained 122 for the client and the payment processed 123. A determination is made as to payment authorization 124; if authorized, the client is invoiced 127 with accounting copied showing payment made on the account. If the payment is not authorized 124, a determination is made whether or not to retry 125 processing the payment. Choosing to reprocess the payment requires reconfirmation of the credit/debit card details 122 and the payment processing 123 begins again. If the payment is not chosen to be reprocessed, the service provider is alerted 126 to the failed transaction. At that point, and once payment is received, the client may choose other functions within the system, such as choosing to add coverage 106, requesting identification cards 132, altering organization details 145, or adding a colleague 109.

Once coverage is activated 130, a new card is requested 131, one for each of the identified vessels, facilities, or agencies. The details for delivery of the cards are determined 135; the Web interface with the client allows the delivery details for the requested cards to be the same as those for other cards assigned for the same client or the client may choose different delivery options. The minimum number of individual cards for each entity is assigned 136, and the client chooses 137 whether or not to request more cards. If the client chooses 137 to request more cards, the client identifies 133 the vessel, facility, agency or individual to whom the card(s) will be issued. If the client adds a vessel, facility or agency, the request for a card is added 134 to the clients request for a card reissued for any vessel, facility or agency already covered under the client's contract with the service provider. The delivery details for the additional cards are determined 135, the minimum number of cards is assigned 136, and the client is prompted 137 once again to identify whether or not they wish to request additional cards. If the client chooses 137 to request an additional card for an individual or individuals, the client identifies 138 the quantity required and adds 139 the number of cards required to the existing request. The client then selects 140 which vessel, facility or agency to which the cards are to be assigned. There is a finite number N cards that can be ordered for a single vessel, facility or agency in a single session, where N is greater than one (1) but is less than a number of cards that the service provider determines may feasibly be ordered in a single session. The client, after selecting 140 to which vessel, facility or agency the cards are to be assigned, is then redirected to choose 137 whether or not the client wishes to request more cards.

The process of requesting more cards may be repeated as many times as necessary for the client to have assigned the appropriate number of cards up to the designated limit that may be ordered in a single session.

If the client confirms the number of cards without requesting additional cards, the request for a batch dispatch of the cards is stored 141 and an email order for the dispatch of the cards is sent 142 to the appropriate agency within the service provider's organization. An acknowledgment of the dispatch order is sent 143 to the client via email and the client acknowledges 144 receipt of the same.

Once the client has acknowledged 144 receipt of the card order confirmation, the client is prompted to return to the main interface area for current clients, and may choose to add new coverage 106, alter details of the client organization 145, request additional cards 132, or add a colleague 109.

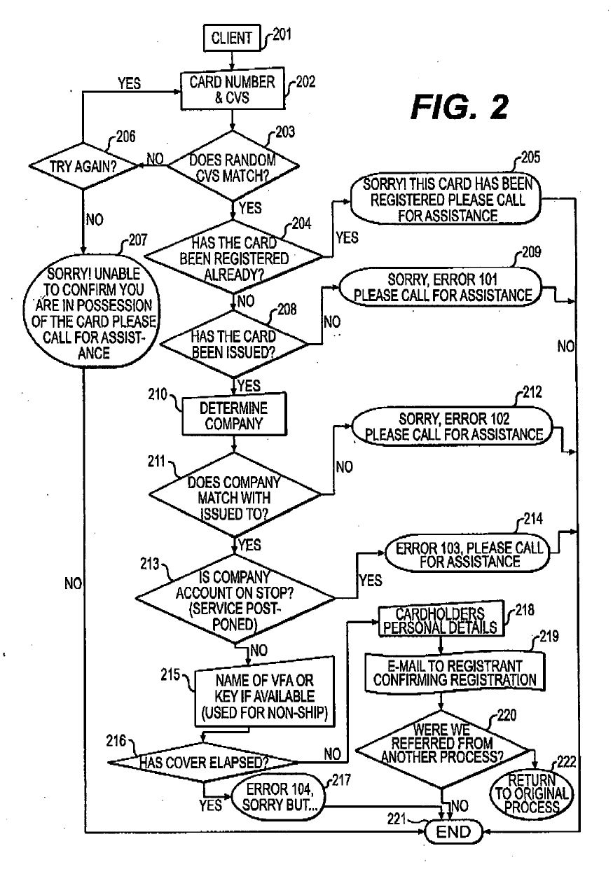

FIG. 2 shows the client registration process. To begin the registration process, a client contacts 201 the service provider and is identified 202 by its designated card number and CVS number, also located on the card. The CVS number is checked 203 against the correct number on file with the service provider; if the CVS number does not match the correct number on file with the service provider, the client may choose 206 to try again to be identified 202 by the client's card number and CVS number. If the client chooses 206 not to try again, the client is notified 207 of the inability of the service provider to confirm the client's account status and the registration process ends 221.

If the CVS number matches the client's account and card number on file, it is determined 204 if the card has already been registered with the service provider. If the card has already been registered with the service provider, the client is prompted 205 that the card has already been registered, and that the client should contact the service provider for further assistance. The process subsequently ends 221. If the card has not already been registered, it is determined 208 whether or not a registered card has already been issued to the client. If the registered card has not already been issued to the client, the client is prompted 209 to contact the service provider for further assistance, and the process ends 221. If the registered card has already been issued, the client to whom the card has been issued is identified 210, and it is determined 211 whether or not the identified client corresponds to the card number on file. If the identified client does not match the card number, the client is prompted 212 to contact the service provider for further assistance and the process ends 221. If it is determined that the client information matches the card issued, it is determined 213 whether or not the client's account has any administrative or other holds, cancellations, or suspensions against the account. If yes, the client is prompted 214 to contact the service provider and the process ends 221. If no, the client is prompted 215 to enter the name of the vessel, facility, or agency for which the card is to be registered. The client may also provide an identification key for non-vessels. It is determined 216 whether or not coverage for the identified vessel, facility, or agency has elapsed. If yes, the client is notified 217 of the lapse in coverage, instructed to contact the service provider, and the process ends 221. If the coverage has not lapsed, the client is prompted 218 to enter the requested details for the vessel, facility, or agency that will be the cardholder. The client is notified 219 via electronic means of the registration of the card. Once the client has been notified 219 of the registration, it is determined 220 whether or not the client was referred into the registration process from another process. If yes, the client is returned 222 back to the original process. If not, the process ends 221.

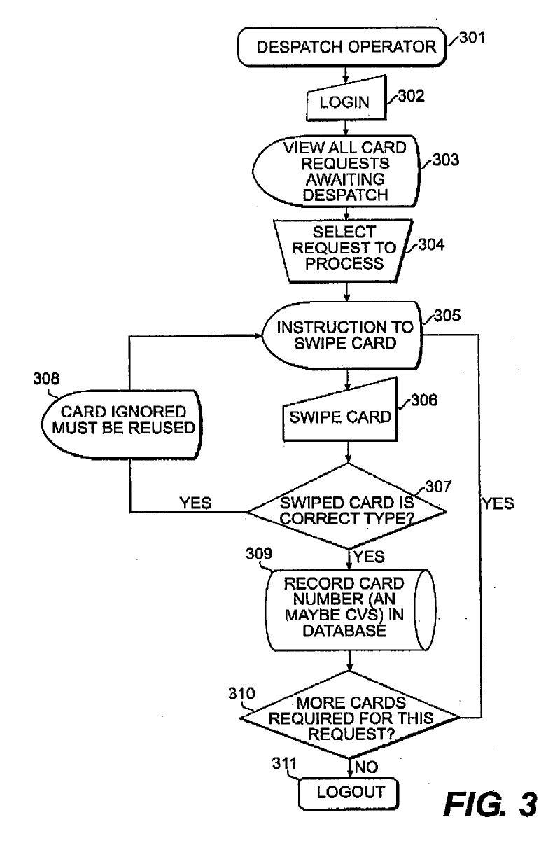

FIG. 3 is a flow chart showing the process by which registered cards with unique registration numbers are dispatched to the to the client. A dispatch operator 301 is prompted to login 302 to the dispatch process and views 303 all cards awaiting dispatch to the respective clients. It will be understood that, in the context of the present invention, “operator” may refer to either a human interface, a software or other electronic or artificial interface, or a combination thereof. The dispatch screens accessible to the dispatch operator 301 are grouped first by delivery address, then by the vessel, facility, or agency, and show the delivery addresses for multiple cards. This is important where a single client has chosen to register multiple cards for various vessels, facilities, and agencies that may be geographically dispersed.

The dispatch operator 301 selects 304 to process cards that are awaiting dispatch. The dispatch operator 301 is prompted 305 to magnetically swipe the card through a card reader/programmer, and the dispatch operator 301 swipes 306 the card through the card reader/programmer. The card is given a unique card number through common electromagnetic programming on the magnetic strip on the back of the card. It is determined 307 whether or not the card swiped is the correct card for the operation selected. If not, the card is ignored 308, and the dispatch operator is again prompted 305 to swipe the card. This is repeated until the dispatch operator and/or supervisor determines that the card is either the wrong card or faulty, or the card is determined 307 to be the correct card and is electronically readable by the card reader/programmer. Once a card is determined 307 to be the correct card and is readable by the card reader/programmer, the card number and CVS number are recorded 309 in the service provider's database. The database also records that the card has been dispatched and to which vessel, facility, or agency the card has been allocated. The dispatch operator 301 is prompted 310 to process additional cards for the particular client and, if additional cards are to be processed, is prompted 305 to swipe the additional card(s). If no further cards are required to be dispatched for the particular client, the dispatch operator is prompted 311 to log out of the process.

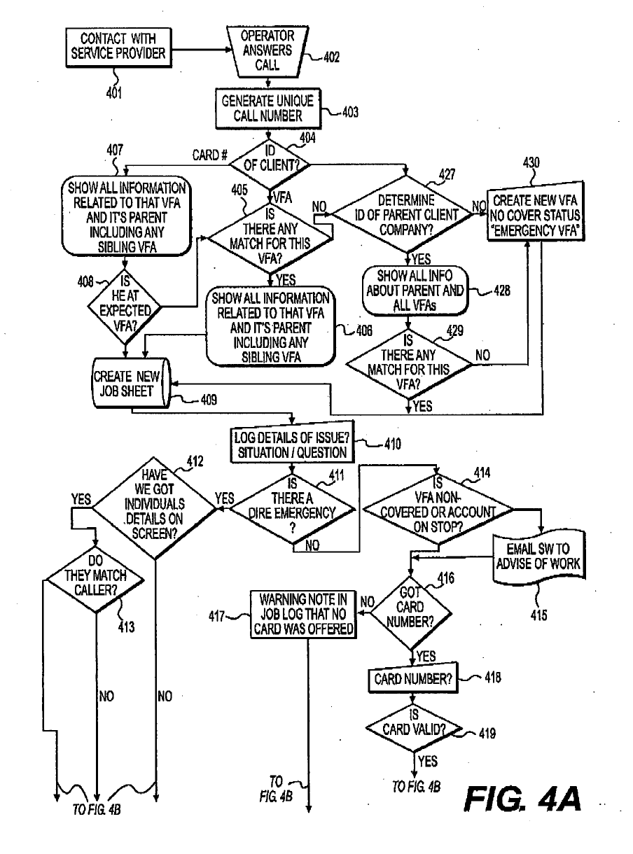

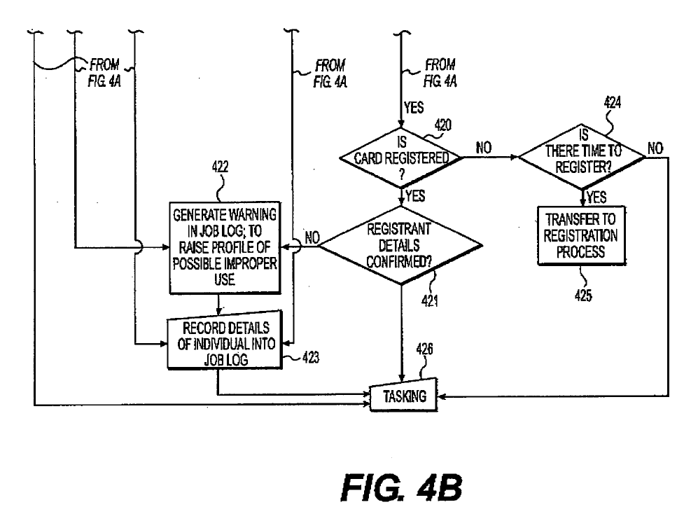

FIG. 4 is a flow chart setting forth the means by which the service provider renders the required services to registered clients. The individual contacting the service provider, who may be a client's officer, agent, or employee and/or the officer, agent, or employee of a registered vessel, facility or agency, contacts 401 the service provider by telephone, electronically, or by other means. An operator responds 402 to the call or electronic contact and generates 403 a unique call number identifying the individual contact event. As above, it will be understood that, in the context of the present invention, “operator” may refer to a human interface, a software or other electronic artificial interface, or a combination thereof. It will also be understood that the contact means used by the client and the service provider through the operator includes electronic communication means, data communication means, and other similar communication means. The operator identifies 404 whether the client is a vessel, facility, or agency and whether or not the client has a registered card. If not, the operator determines 427 the identification of the parent client company and whether or not the parent client company has any existing information in the service provider's database. The parent client company may be a company that operates numerous vessels and/or facilities or the like. If the parent client company is identified in the service provider's database, the operator is shown 428 all information related to the parent client company as well as to all vessels, facilities, and/or agencies associated with that parent client company. The operator then determines 429 whether there are any matches between the information related to the parent client company and the client vessel, facility, or agency contacting the service provider. If there is a match, a new job sheet is created 409. If there is no match between the information related to the parent client company and the client vessel, facility, or agency contacting the service provider, a new vessel, facility or agency “no cover status for an emergency vessel, facility or agency” is created 430, along with a new job sheet is created 409. If a parent client company cannot be determined 427, a new vessel, facility or agency “no cover status for an emergency vessel, facility or agency is created 430, along with a new job sheet is created 409.

If the operator identifies 404 that the client vessel, facility, or agency has a registered card but no card number is identified, a determination is made 405 whether or not there is any match in the service provider's database for the client vessel, facility, or agency. If not, the operator determines 427 the identification of the parent client company and whether or not the parent client company has any information in the service provider's database. If there is a match in the service provider's database for the client vessel, facility, or agency, the operator is shown 406 all information related to the parent client company, as well as to all vessels, facilities, and/or agencies associated with that parent client company, and a new job sheet is created 409.

If the operator identifies 404 that the client vessel, facility or agency has a registered card and the card number is identified, the operator is shown 407 all information related to the parent client company as well as to all vessels, facilities, and/or agencies associated with that parent client company. A determination is made 408 whether or not the card number associated with the client contacting the service provider is, at the time of the contact, at the vessel, facility, or agency associated with that card number. If not, a determination is made 405 whether or not there is any match in the service provider's database for the client vessel, facility or agency and the process proceeds as discussed above.

Once a new job sheet is created 409 for a client, the operator logs 410 the details of the client's reason(s) for contacting the service provider which may include, for example, that the client has: 1) security or other issues that requires an immediate, as-needed response; 2) a routine issue that requires a response; or 3) another question or query. If possible, responses to contacts by a client are provided immediately, on an as-needed basis. If it is determined 411 that the client is contacting the service provider with an emergency and the client's individual details are located in the service provider's database and shown 412 to the operator, the operator then determines 413 whether or not the client details shown 412 match the contacting client. If yes, the job is tasked 426 as required. If the client's individual details are not shown 412 to the operator, the operator records 423 the individual client details into the job log, and the job is tasked 426 as required. If the client's individual details are shown 412 but that information is not determined 413 to match that of the contacting client, a warning is generated 422 in the job log. This warning serves to ‘flag’ that particular contact event for further determination of improper and/or illegal activity. The operator then records 423 the individual client details into the job log and the job is tasked 426 as required.

Where it is determined 411 that the client is contacting the service provider for a matter that does not qualify as an emergency, it is then determined 414 whether or not the client vessel, facility, and/or agency is a current client and, if so, whether or not coverage for the identified vessel, facility, or agency has elapsed. If yes, the service provider is notified 415 of the contact and job request for further administrative action and the process proceeds as set forth below. Once it is determined 414 that the client vessel, facility and/or agency has current coverage, the client is prompted 416 to provide the card number registered with the service provider.

If the client does not have ready access to the card number at the time of the contact, a note is entered 417 in the job log that no card number was offered. The operator records 423 the individual client details into the job log and the job is tasked 426 as required.

If the card number is provided 418 by the client, the operator determines 419 if the card number and the CVS number on the card are valid. If the card number and CVS number are both valid, it is determined 420 whether or not the card is registered. If not, it is determined 424 whether or not there is sufficient time to register the card prior to tasking. In some circumstances, the issue that the client is confronting, although not an emergency, may require immediate tasking. If there is insufficient time to have the client attend to the card registration process prior to tasking, the job is tasked 426 as required. If, however, there is sufficient time prior to tasking, the client is transferred 425 to the registration process as discussed above.

If the card number and CVS number are both valid and the card is already registered, the details of the card registrant are confirmed 421. If the details of the card registrant do not match the client contacting the service provider, a warning is generated 422 in the job log and the process proceeds as above. If the details of the card registrant match the client contacting the service provider, the job is tasked 426 as required.

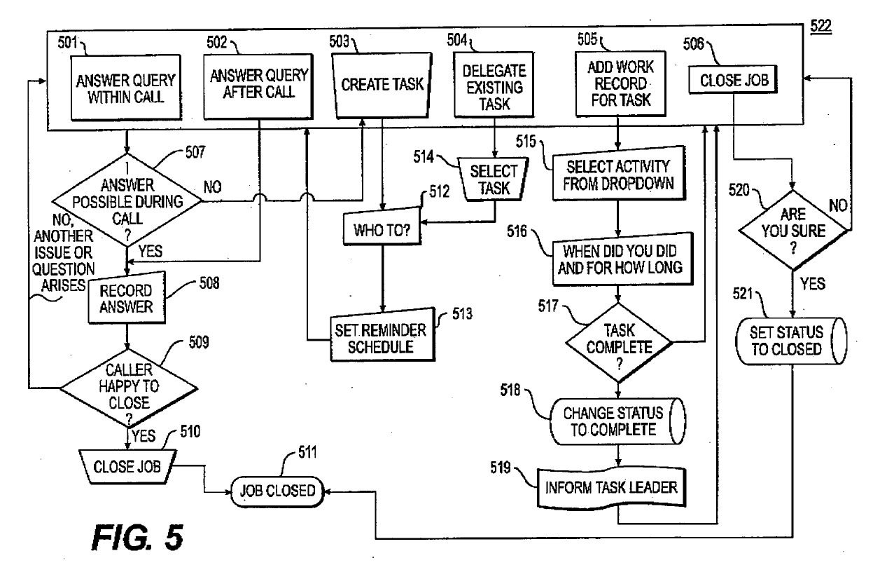

FIG. 5 is a flow chart setting forth the process by which a request for services is tasked out and tracked. Once a client has been directed to job tasking as described above, there are several possible actions 522 that may be taken pertaining to a particular job. A query from a client may be answered during the contact 501 or may be answered after the contact 502. A task may be created 503, an existing task delegated 504, a new work record for a task added 505 to the existing task, and, finally, a job may be closed 506. The operator determines 507 if it is possible to answer a query during the contact 501. If it is not possible to answer the query during the contact 501, a task is created 503. Subsequently, it is determined 512 to whom or what the task should be directed and/or assigned, and a reminder is scheduled 513 for the operator to follow up and determine the status of the task at a later time. The operator is then returned to the possible actions 522 that may be taken in response to the contact. If the query is to be answered after the contact 502, the answer is recorded 508 and the client is queried 509 as to whether there are additional matters that the client may need to have addressed during the contact. If the client has no further matters and is content to close the contact, the operator is directed 510 to close 511 the job. If there are further matters that need to be addressed during the contact, the operator is redirected to the possible actions 522 that may be taken in response to the contact.

If it is possible to answer the query within the contact 501, the answer is recorded 508, and the client is queried 509 as to whether or not there are additional matters that the client may need to have addressed during the contact. The process then proceeds as set forth above. Where an existing task is delegated 504 for action, the particular task delegated 504 is selected 514, and it is determined 512 to whom or what the task should be directed and a reminder scheduled 513 for the operator to follow up and determine the status of the task at a later time. The operator is then returned to the possible actions 522 that may be taken in response to the contact.

The operator may also add 505 a work record for the task. A particular activity to be accomplished on the task is then chosen 515 and a summary of which action was taken is recorded 516. The operator determines 517 whether or not the task is complete. If the task is complete, the status of the task is changed 518 to “complete”, the task leader is informed 519 of the completion, and the operator is returned to the possible actions 522 that may be taken on the contact. If the task is determined 517 not to be complete, the operator is returned to the possible actions 522 to be taken on the task.

The operator may also choose 506 to close the job. The operator is prompted 520 to confirm that the operator wishes to close the task. If not, the operator is redirected to the possible actions that may be taken, 522 on the contact. If the operator confirms that the job should be closed, the status of the job is set 521 as “closed” and the job is closed 511.

The invention has been described in connection with a preferred embodiment thereof, and it should be clear to one skilled in the art that modifications and changes therein may be made by one skilled in the art without departing from the spirit and the scope of the invention. The details of the present invention as described are illustrative only, and do not limit the scope of the present invention as claimed below.

What is claimed is:

1. A method for providing services and information to clients, comprising:
(1) processing orders for a plurality of clients;
(2) registering a plurality of clients with a service provider;
(3) dispatching registered cards to a plurality of clients;
(4) providing services for a plurality of registered clients; and
(5) tracking job and task assignments for a plurality of clients.

2. The method of claim 1 wherein said steps of processing orders, registering a plurality of clients, dispatching services and information, providing services and information, and tracking job and task assignments include electronic communication means for said steps.

3. The method of claim 2 wherein said electronic communication means is provided via the World Wide Web.

4. The method of claim 2 wherein said electronic communication means is provided via voice communications.

5. The method of claim 1 wherein said steps of processing orders, registering a plurality of clients, dispatching services and information, providing services and information, and tracking job and task assignments is done on an as-needed basis.

6. The method of claim 1 wherein said step of processing orders for a plurality of clients includes the steps of:
a client contacting a service provider;
a service provider determining if the client is a existing client;
generating a unique username and password for a existing client; and
providing a existing client with a plurality of service choices.

7. The method of claim 6 wherein a service relationship is created with a client.

8. The method of claim 7, wherein said plurality of service choices include the steps of:
adding a colleague;
changing existing client information;
adding service coverage for a existing client;
processing payment for services; and
requesting additional registered cards.

9. The method of claim 8, wherein said processing of payment for services includes the steps of:
accepting and processing a credit or debit card payment; and
confirming payment.

10. A method for registering a unique identification card including the steps of:
gathering client information; and
matching client information to unique registered card numbers.

11. The method of claim 10, wherein the step of matching client information to unique registered card numbers comprises the steps of:
confirming registered ownership to the unique identification card number;
confirming colleague registration for the unique identification card number; and
determining whether or not the client has active service coverage.

12. A method for dispatching registered identification cards to clients including the steps of:
logging a client into a service process;
displaying data related to registered identification cards waiting dispatch;
requesting to register a card or cards;
electromagnetically imprinting a card with unique client information; and
recording the card number in a client database.

13. A method of providing services to clients including the steps of:
identifying a unique identification card number; and
identifying jobs to be tasked for a client.

14. The method of claim 13, wherein the step of identifying a unique identification card number includes:
identifying a client associated with a unique card;
displaying all available client information;
confirming coverage of a identified client; and
registering an unregistered client.

15. The method of claim 14, further comprising the step of identifying a colleague associated with a identified client.

16. The method of claim 14, wherein confirming coverage of a identified client further comprises the step of generating a improper use warning if coverage is not confirmed.

17. The method of claim 13, wherein identifying jobs to be tasked for a client includes:
creating a new job sheet;
logging details of a job request; and
classifying a job request.

18. The method of claim 17, wherein a job request may be classified as emergency or non-emergency.

19. A method of tasking a job for a client including the steps of:
responding to contact by a client;
creating a task;
creating a work record; and
completing the job task process.

20. The method of claim 19, wherein responding to contact by a client includes determining whether or not a request for services by a client may be attended to during the contact.

21. The method of claim 19, wherein creating a task includes:
selecting and assigning a task;
delegating an existing task; and
setting a reminder to follow up on an assigned task.

22. The method of claim 19, wherein creating a work record includes choosing a task from a display menu of task options.

23. A method of processing orders for a client including the steps of:
a client contacting a service provider;
a service provider determining if the client is a existing client;
generating a unique username and password for a existing client; and
providing a existing client with a plurality of service choices.

24. The method of claim 23 wherein a service relationship is created with a client.

25. The method of claim 23, wherein said plurality of service choices include the service choices of:
adding a colleague;
changing existing client information;
adding service coverage for a existing client;
processing payment for services; and
requesting additional identification cards.

26. The method of claim 25, wherein said processing of payment for services includes the steps of:
accepting and processing a credit or debit card payment; and
confirming payment.

27. A system for providing services and information to clients, comprising:
(1) means for processing orders for a plurality of clients;
(2) means for registering a plurality of clients with a service provider;
(3) means for dispatching services and information to a plurality of clients;
(4) means for providing services for a plurality of registered clients; and
(5) means for tracking job and task assignments for a plurality of clients.

28. The system of claim 27 wherein said means for processing orders, registering a plurality of clients, dispatching services and information, providing services and information, and tracking job and task assignments are electronic communication means.

29. The system of claim 28 wherein said electronic communication means is the World Wide Web.

30. The system of claim 28 wherein said electronic communication means is voice communications.

31. The system of claim 27 wherein said means for processing orders, registering a plurality of clients, dispatching services and information, providing services and information, and tracking job and task assignments further comprises means to process orders, register a plurality of clients, dispatch services and information, provide services and information and track job and task assignments on an as-needed basis.

32. The system of claim 27 wherein said means for processing orders for a plurality of clients includes means for:
a client contacting a service provider;
a service provider determining if the client is a existing client;
generating a unique username and password for a existing client; and
providing a existing client with a plurality of service choices.

33. The system of claim 32 wherein said system includes means for creating a service relationship with a client.

34. The system of claim 33, wherein said means for providing a existing client with a plurality of service choices includes means for:
adding a colleague;
changing existing client information;
adding service coverage for a existing client;
processing payment for services; and
requesting additional identification cards.

35. The system of claim 34, wherein said means for processing of payment for services comprises means for:
accepting and processing a credit or debit card payment; and
confirming payment.

36. A system for registering a unique identification card including means for:
gathering client information; and
matching client information to registered card numbers.

37. The system of claim 36, wherein the means for matching client information to registered card numbers comprises:
confirming registered ownership of a unique identification card number;
confirming colleague registration for a unique identification card number; and
determining whether or not the client has active service coverage.

38. A system for dispatching cards to clients including means for:
logging a client into a service process;
displaying data related to identification cards waiting dispatch;
requesting to process a card or cards;
electromagnetically imprinting a card with unique client information; and
recording the card number in a client database.

39. A system for providing services to clients including comprising means for:
identifying a unique identification card number; and
identifying jobs to be tasked for a client.

40. The system of claim 39, wherein the means for identifying a unique identification card number further comprises means for:
identifying a client associated with a unique card;
displaying all available client information;
confirming coverage of a identified client; and
registering an unregistered client.

41. The system of claim 40, further comprising means for identifying a colleague associated with a identified client.

42. The system of claim 41, wherein the means for confirming coverage of a identified client further comprises means for generating a improper use warning if coverage is not confirmed.

43. The system of claim 42, wherein the means for identifying jobs to be tasked for a client includes means for:
creating a new job sheet;
logging details of a job request; and
classifying a job request.

44. The system of claim 43, wherein a job request may be classified as emergency or non-emergency.

45. A system for tasking a job for a client comprising means for:
responding to contact by a client;
creating a task;
creating a work record; and
completing the job task process.

46. The system of claim 45, wherein the means for responding to contact by a client includes means for determining whether or not a request for services by a client may be attended to during the contact.

47. The system of claim 46, wherein the means for creating a task includes means for:
selecting and assigning a task;
delegating an existing task; and
setting a reminder to follow up on an assigned task.

48. The system of claim 47, wherein the means for creating a work record includes means for choosing a task from a display menu of task options.

49. A system of processing orders for a plurality of clients including means for:
a client to contact a service provider;
a service provider to determine if the client is a existing client;
generating a unique username and password for a existing client; and
providing a existing client with a plurality of service choices.

50. The system of claim 49 further comprising means for creating a service relationship with a client.

51. The system of claim 50, wherein said means for providing a existing client with a plurality of service choices includes means for:
adding a colleague;
changing existing client information;
adding service coverage for a existing client;
processing payment for services; and
requesting additional identification cards.

52. The system of claim 51, wherein said means for processing of payment for services comprises means for:
accepting and processing a credit or debit card payment; and
confirming payment.
